(19) United States
(12) Patent Application Publication
(10) Pub. No.: US 2015/0290973 A1
(43) Pub. Date: Oct. 15, 2015

(54) Light Weight Axle Housing

(71) Applicant: Caterpillar Inc., Peoria, IL (US)

(72) Inventors: Donald Stamets, Bloomington, IL (US); Timothy Halsmer, Byron, IL (US); Christy Lee, Eureka, IL (US)

(73) Assignee: Caterpillar Inc., Peoria, IL (US)

(21) Appl. No.: 14/253,196

(22) Filed: Apr. 15, 2014

(51) Int. Cl. B60B 35/16; B21D 53/90

(52) U.S. Cl. CPC B60B 35/166; B21D 53/90; B60B 2900/111; B60B 2900/112; B60B 2900/113

(57) ABSTRACT

An axle housing for an axle assembly of a vehicle is provided where the axle housing includes a center leg portion, an outer bearing configured to mount onto one end of the center leg portion, and an inner bearing configured to mount onto the opposite end of the center leg portion. The center leg portion includes a first metal sleeve, a second metal sleeve surrounding the first metal sleeve, and a corrugated inner sleeve arranged between the first and second metal sleeves. The corrugated inner sleeve has a series of corrugations that include first portions and second portions wherein the first portions are affixed to the first metal sleeve and the second portions are affixed to the second metal panel. A plurality of channel regions between the corrugations and the first metal panel and the second metal panel is formed within the axle housing.

### TECHNICAL FIELD

The present disclosure generally relates to axle housings, and more particularly to reducing the weight of axle housings and methods of fabricating axle housings of lighter weight for vehicles or machines used in earth moving, construction, material handling, and mining applications.

### BACKGROUND

Vehicle frames are often supported by axle housings that partially enclose axles on which wheels or other ground engaging members are mounted. Inertial forces exerted through die vehicle frames act on the axle housings in a first dire while the ground engaging members, which are used to propel the vehicles, exert reaction forces on the axle housings in a second, opposed direction. Of course, if the subject vehicle is pushing or drawing a load; the forces acting on the axle housing increase substantially beyond the inertial and reaction forces and must also be operationally accommodated by the axle housing. Therefore, design considerations for vehicles, and in particular for heavy-duty machines, require that the axle housing must be strong enough to withstand inertia forces or lateral strain.

Various methods have been used to manufacture axle housings all of which are expensive because of the type of material used, the amount of material wasted or the labor and time required. Axle housings are generally either cast in steel, ductile iron, or fabricated from steel. While steel axle housings provide the necessary strength for many heavy-duty machine applications, steel makes the machine heavier and less efficient Axle housings made from steel are also expensive and often difficult to manufacture requiring many time consuming steps during casting and fabrication. Therefore, there is a desire to reduce the amount of steel needed to form axle housings.

Different strategies have been employed to strengthen and facilitate the manufacture of axle housings. For example, U.S. Pat. No. 1,403,500 (“Huff”) issued Jan. 17, 1922, discloses a prior art rear-axle housing for a motor vehicle. FIG. 1 of Huff illustrates a fabricated steel axle housing that includes an intermediate portion that has longitudinal corrugations. According to Huff, these longitudinal corrugations are designed to provide additional support for the tubular portions of the axle housing against lateral strains.

While prior art axle housings are useful to some extent, there remains a need for a stronger, yet lighter weight axle housing that uses less steel. Accordingly, the presently disclosed axle housing and methods for fabricating an axle housing is directed at overcoming one or more of these disadvantages in currently available axle housings.

### SUMMARY OF THE DISCLOSURE

In accordance with one aspect of the disclosure, an axle housing for an axle assembly of a vehicle is disclosed. The axle assembly includes a center leg portion, an outer bearing configured to mount onto one end of the center leg portion, and a differential housing configured to mount onto the opposite end of the center leg portion. The center leg portion includes a first metal sleeve, a second metal sleeve surrounding the first metal sleeve, and a corrugated inner sleeve arranged between the first and second metal sleeves. The corrugated inner sleeve has a series of corrugations that include first portions and second portions wherein the first portions are affixed to the first metal sleeve and the second portions are affixed to the second metal panel. A plurality of channel regions between the corrugations and the first metal panel and the second metal panel is formed within the axle housing.

In accordance with another aspect of the disclosure, an axle housing is provided. The axle housing includes a center leg portion having an attaching structure configured to attach to a differential housing, a first sleeve defining an outer perimeter of the center leg portion, and a second sleeve containing the first sleeve. The axle housing further includes a corrugated section connecting the first sleeve with the second sleeve, wherein the corrugated section, the first sleeve, and the second sleeve define channel regions within the axle housing.

In accordance with another aspect of the disclosure, a method of assembling an axle housing is disclosed. The method includes connecting an inner sleeve and an outer sleeve with a corrugated portion to form a center leg portion; attaching the center leg portion to an outer bearing; and forming channel regions defined by the inner sleeve, the outer sleeve, and the corrugated portion, wherein at least one of the inner sleeve, the outer sleeve, and the corrugated portion is metal.

### BRIEF DESCRIPTION OF THE DRAWINGS

FIG. 1 is a perspective view of one embodiment of an axle housing assembly constructed in accordance with the teachings of the present disclosure.

FIG. 1A is an exploded, partial, perspective, cross-sectional view taken along line 1A-1A of FIG. 1 of one embodiment of an axle housing assembly constructed in accordance with the teachings of the disclosure.

FIG. 2 is a cross-sectional view taken along the line 2,3-2,3 of FIG. 1 of one embodiment of a center leg portion of an axle housing constructed in accordance with the teachings of the disclosure.

FIG. 3 is a cross-sectional view taken along the line 2,3-2,3 of FIG. 1 of another embodiment of a center leg portion of an axle housing constructed in accordance with the teachings of the disclosure.

FIG. 4 is a perspective view of one embodiment of a metal composite assembly constructed in accordance with the teachings of the present disclosure.

### DETAILED DESCRIPTION

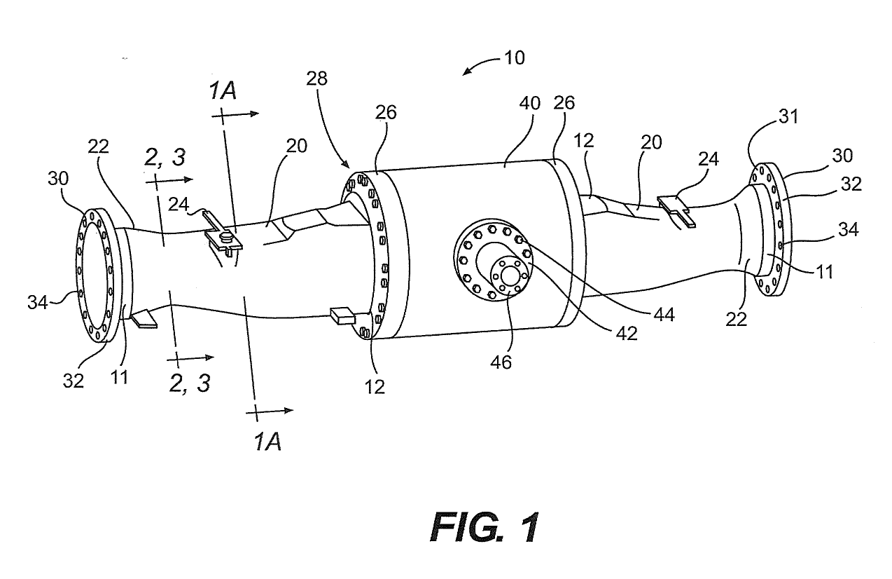

Referring now to FIG. 1, an axle housing assembly 10 is shown. The axle housing assembly 10 includes a center leg portion 20, an outer bearing 30 and a differential housing 40. The center leg portion 20 extends to form two ends 11, 12. The outer bearing 30 is configured to mount onto one end 11 of the center leg portion 20 opposite the end 12 attached to the differential housing 40. The differential housing 40 is configured to mount onto the end of the center leg portion 20 that is opposite the outer bearing 30. An additional center leg portion 20 and another outer bearing 30 also attach to the differential housing 40 as shown.

FIG. 1A is a cross-sectional view of the axle housing assembly 10 taken along line 1A-1A shown in FIG. 1. The axle housing assembly 10 shown in FIG. 1A has a portion of the center leg portion 20 removed such that an interior of the center leg portion 20 is exposed for clarity. It should be understood, however, that an additional center leg portion 20 and outer bearing 30 will be included to form a complete axle housing assembly 10 as shown in FIG. 1 but because the second center leg portion 20 and outer bearing 30 are mirror images of one another only one is shown and described in FIG. 1A to avoid overcrowding FIG. 1A.

The center leg portion 20 may be substantially cylindrical in shape and may or may not have a uniform diameter. In some embodiments, the diameter of the center leg portion 20 may vary from one end 11 to the other end 12 of the center leg portion 20. In other embodiments, the circular cross-section may be non-uniform from one end 11 to the other end 12. Geometries that are non-cylindrical are also contemplated for the center leg portion 20. For example, the center leg portion 20 may be rectangular having a rectangular cross-section. In some embodiments, the center leg portion 20 may have a rectangular cross-section with rounded corners. The outer bearing 30 and the differential housing 40 may be formed from a steel or iron casting. The center leg portion 20 may be fabricated using steel, iron, or other suitable materials as explained in detail below.

The axle housing assembly 10 may include a receiving portion 22 located on the center leg portion 20 receiving the outer bearing 30. The outer bearing 30 may include an attaching hub 32 having holes 34 to allow a wheel (not shown) and/or other structure to attach to the attaching hub 32. The center leg portion 20 may also include mounting structure 24 to allow the axle housing assembly 10 to be attached to a vehicle. The center leg portion 20 may also include an attaching flange 26 so that the center leg portion 20 may be attached to the differential housing 40.

As shown in FIG. 1, the center leg portion 20 is attached to the differential housing 40 via fasteners 28 connecting the attaching flange 26 of the center leg portion 20 to the differential housing 40. The differential housing 40 may have an attaching plate 42 attached to the differential housing 40 via fasteners 44. A shaft 46 may extend out of the attaching plate to attach to a drive shaft (not shown). In other embodiments, rather than a shaft 46 extending from the differential housing 40, the differential housing may simply have a hole to permit a drive shaft to enter the differential housing to attach to the differential.

In other embodiments in accordance with the present disclosure, the center leg portion 20 may be attached to the differential housing 40 in a variety of ways and is not limited to that shown and described. Further, it should be understood that the outer bearing 30 may also attach to the center leg portion 20 in a variety of ways and is not limited to that shown in the example of FIG. 1.

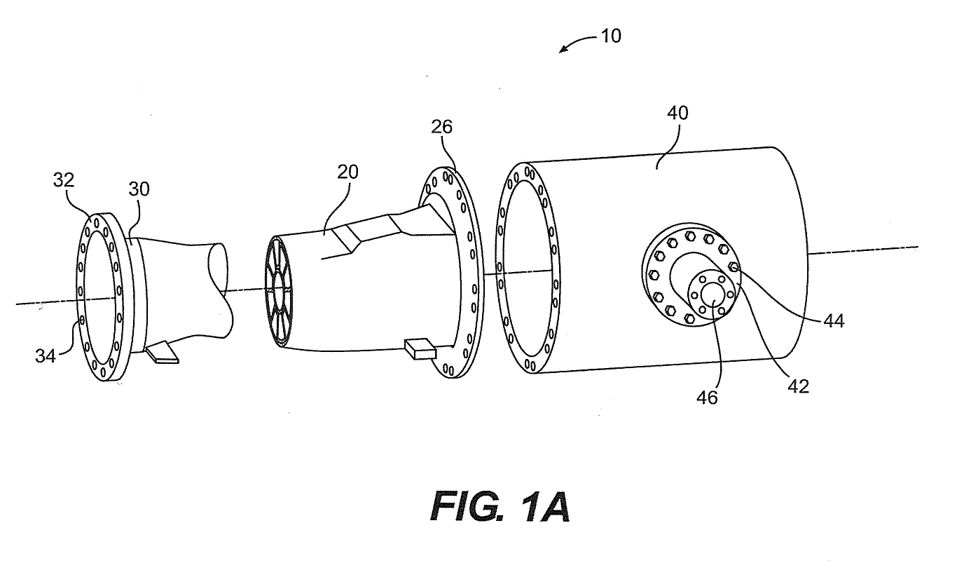

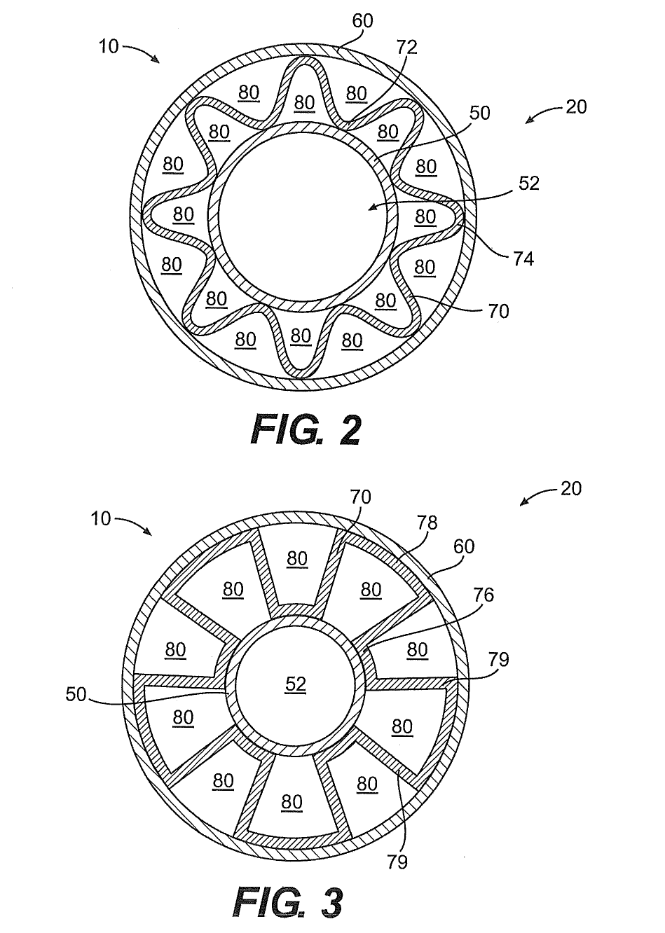

FIGS. 2 and 3 are cross-sectional views of the center leg portion 20 taken along the line 2,3-2,3 shown in FIG. 1. FIGS. 2 and 3 differ in cross-section as they illustrate different embodiments which could be used in accordance with an axle housing as shown in FIG. 1.

FIG. 2 illustrates a cross-section of the center leg portion 20 which includes a first sleeve 50, a second sleeve 60 and a corrugated sleeve 70. In some embodiments, the sleeves 50, 60 are metal. The opening 52 (also seen in FIG. 3) defined by the first sleeve 50 provides a space for an axle (not shown) to reside in the axle housing assembly 10. The second sleeve 60 surrounds the first sleeve 50. The corrugated sleeve 70 is arranged between the first sleeve 50 and the second sleeve 60. The corrugated sleeve 70 provides additional structural support to the center leg portion 20 of the axle housing assembly 10 and is connected the first 50 and second 60 sleeves.

The first and second sleeves 50, 60 may have circular cross-sections that are consistent with the geometry of the center leg portion 20. In other embodiments, the cross-sections may not be exactly circular. For example, the cross-section of the second sleeve 60 at the location of the mounting structure 24 (see FIG. 1) would not be exactly circular. Other variations may also be contemplated in accordance with the present disclosure. The overall diameter of the first sleeve 50 is smaller than the overall diameter of the second sleeve 60.

The first and second sleeves 50, 60 may differ in the thicknesses of the material used. For example, the second sleeve 60 may have a thickness that is greater than the thickness of the first sleeve 50. Alternatively, the first sleeve 50 may have a thickness that is greater than the thickness of the second sleeve 60.

The first and second sleeves 50, 60 can be fabricated from a variety of materials, such as stainless and high-strength steel, aluminum and titanium. In some embodiments, nonmetal materials such as composites, ceramics, or any other suitable material may also be used for one or both of the sleeves 50, 60. It is also contemplated that the first and second sleeves 50, 60 may be made from different metals or materials. For example, the second sleeve 60 may be made from steel while the first sleeve 50 may be composed of stainless steel.

Various surface treatments may be used on the first and second sleeves 50, 60 to ensure proper corrosion resistance. The first and second sleeves 50, 60 may also be coated with paint and/or any other suitable coating material to further improve the corrosion resistance of the first and second sleeves 50, 60.

The corrugated sleeve 70 can be fabricated from a variety of materials, such as stainless steel, high-strength steel, aluminum and titanium or other materials and is not limited to metal. In other embodiments nonmetal materials may be used such as resins, composites, ceramics, or any other suitable material. The corrugated sleeve 70 has a series of corrugations that include first portions 72 and second portions 74. As shown in FIG. 2, the first portions 72 alternate and oppose the second portions 74. As shown in FIG. 3, the first arc portions 76 oppose second arc portions 78 and the arc portions 76 and 78 share a side wall 79.

The first portions 72 are affixed to the first sleeve 50. In some embodiments, the first portions 72 are laser welded to the first sleeve 50. The second portions 74 are affixed to the second sleeve 60. In some embodiments, the second portions 74 are laser welded to the second sleeve 60. The corrugated sleeve 70 is affixed to both the first sleeve 50 and the second sleeve 60 such that the center leg portion 20 may be fabricated as a unitary piece. Laser welding may make the fabrication process easier because it uses a lower heat input and therefore minimizes any thermal distortion that may result from the welding process.

Other types of welding, however, may be also used to join the corrugated sleeve 70 to the first and second sleeves 50, 60. For example, plasma arc welding, electric arc welding, gas welding, friction stir welding and brazing may be used. The welding process selected may in large part depend on the type and grade of metals that the first and second sleeves 50, 60 and the corrugated sleeve 70 are composed. For example, those skilled in the art will recognize that certain welding processes will be more suitable to join certain metals together and certain metal combinations together. Alternative means of joining the corrugated sleeve 70 to the first and second sleeves 50, 60 are also contemplated and may include using adhesives such as epoxy, glue, and mechanical fasteners such as (but not limited to) bolts and rivets.

FIGS. 2 and 3 illustrate cross-sectional views of different embodiments of a center leg portion 20 of the axle housing assembly 10. For example, FIG. 2 illustrates first and second portions 72, 74 that are curved. These corrugations have a sinusoidal or wave-like form wherein the crest of each first portion 72 is affixed to the first sleeve 50 and the crest of each second portion 74 is affixed to the second sleeve 60.

Each individual corrugation has amplitude and a wavelength. In some embodiments, the series of corrugations may be uniform having the same wavelength and amplitude extending throughout the entire corrugated sleeve 70. However, it is possible to form a series of corrugations that is non-uniform or varies in wavelength and/or amplitude throughout the corrugated sleeve 70.

The geometry of the corrugations, i.e., the shape, the amplitude and the wavelength may be selected in order to adjust the strength and the weight of the axle housing assembly 10, as needed. For example, increasing the wavelength of the corrugations may also increase the stiffness of the center leg portion 20. Decreasing the wavelength of the corrugations may decrease the stiffness or increase the flexibility of the center leg portion 20. Similarly, the geometric shape used to form the series of first and second portions 72, 74 for the corrugated sleeve 70 affects the structure of the center leg portion 20 and may ultimately affect the weight and the strength of the axle housing assembly 10. Additionally, the thickness of the corrugated sleeve 70 and the material used to construct the corrugated sleeve 70 are factors that contribute to the weight and strength of the axle housing assembly 10 constructed according to the present disclosure.

FIG. 3 illustrates corrugations that have a different geometry. These corrugations also include a first arc portion 76 and second arc portion 78 that is affixed to the first and second sleeves 50, 60. For example, the first arc portions 76 are joined to the first sleeve 50. The second arc portions 78 are joined to the second sleeve 60. One consideration for using corrugations having arc portions 76 and 78 is that the arc portions 76, 78 provide a surface area for welding the series of first and second arc portions 76, 78 to the first and second sleeves 50, 60. Numerous other geometries are contemplated to form the corrugations for the corrugated sleeve 70.

In the embodiments shown in both FIGS. 2 and 3, a plurality of channel regions 80 formed by the arrangement of the corrugated sleeve 70 and the first and second sleeves 50, 60. The number of channel regions 80 is determined by the number of corrugations on the corrugated sleeve 70. The size and the shape of the channel regions 80 are determined by the size and shape of the corrugated sleeve and the first and second sleeves 50, 60.

The channel regions 80 may be partially filled or completely filled with a polymeric material. It is also possible to fill some of the channel regions 80 with a polymeric material while leaving some channel regions 80 empty. In some embodiments, at least one of the channel regions 80 may be fitted with a polymeric material. In some embodiments, the channel regions 80 may remain open or void. By filling the channel regions 80, it is possible to adjust the strength of the axle housing assembly 10, as needed.

A wide variety of polymeric materials may be used to fill the channel regions 80. The polymeric material could either be a thermoplastic polymer, a thermosetting polymer or an elastomer. Filled or unfilled polymers may be used. In some embodiments according to the present disclosure, polyurethane is used to fill the channel regions 80. Those skilled in the art will understand that polyurethane includes polyurethane-based polymers or polymers consisting of a chain of organic units joined by urethane links. The polyurethane or polyurethane-based polymers may include other polymer segments, pendant groups and functional groups as necessary. The polymeric material is intended to fill the channel regions as a permanent addition to the overall structure of the axle housing assembly 10 by adding various thermal, chemical and mechanical properties to the center leg portion 20.

The polymeric material may be introduced to the channel regions 80 using a number of well-known methods and depends on the type of polymeric material being used. For thermoplastic polymers, various molding techniques such as injection, compression or blow molding may be used. For thermosetting polymers and resins, the polymeric material may be introduced to the channel regions 80 using a vacuum assist and curing process. Liquid polymeric material may be introduced into the channel regions 80. Once the material has been introduced to the channel regions 80, it may be exposed to conditions that enable it to harden, such as cool temperatures, to first temperature, to pressure, to ultraviolet, infrared, or other radiation, etc. In some embodiments, the channel regions 80 may be used to route fluid for cooling in the axle housing assembly 10. In other embodiments, the channel regions 80 may serve as routing conduit such as lines for lubrication or brake lines, etc.

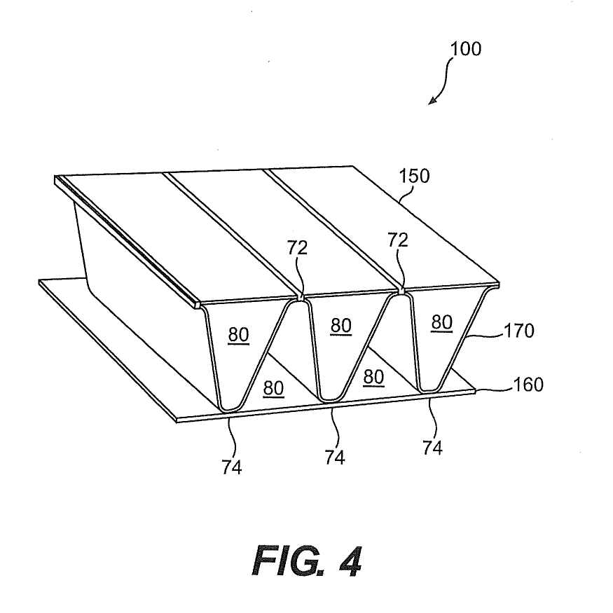

In accordance with an embodiment of the present disclosure, the composite assembly 100 shown in FIG. 4 may be used as a starting material to fabricate the center leg portion 20 shown in FIG. 3. For example, the composite assembly 100 has a layered structure and includes a first panel 150, a second panel 160 and an inner corrugated panel 170 arranged between the first and second panels 150, 160. In some embodiments, the first 150 and second 160 panels are metal. In other embodiments, the first and second panels 150, 160 may be made of other materials. In embodiments where the first and second panels 150, 160 and the inner corrugated panel 170 are metal, the first and second panels 150, 160 and the inner corrugated panel 170 may be fabricated from a variety of materials, such as stainless steel, high-strength steel, aluminum and titanium. In some embodiments, other metals and non-metallic materials may also be used.

The inner corrugated panel 170 has a series of corrugations that include first portions 72 and second portions 74. The first portions 72 are affixed to the first panel 150 and the second portions 74 are affixed to the second panel 160 to form a plurality of channel regions 80 between the first portions 72 and the second panel 160 and between the second portions 74 and the first panel 150.

In some embodiments, particularly where the first and second panels 150, 160 and corrugated panel 170 are metal, laser welding is used to join the first portions 72 to the first panel 150 and the second portions 74 to the second panel 160. In embodiments where the first and second panels 150, 160 and or the corrugated panel 170 are made of materials other than metal or other means of fastening them together maybe used, such as, but not limited to, sonic welding, heat welding, epoxy, glue, fasteners or any other suitable means of attaching these features together.

In some embodiments, the composite assembly 100 is also known as a laser welded, light weight corrugated structure or a LASCOR panel. At least some of the channel regions 80 may be filled with a polymeric material to further strengthen the composite assembly 100 and provide additional rigidity. In some embodiments, the polymeric material may be polyurethane.

The composite assembly 100 or LASCOR panel may, for example, be used as a starting material to fabricate the center leg portion 20. The first panel 150, the second panel 160 and the corrugated panel 170 that make up the composite assembly 100 may be flexed, bent, or folded in any manner necessary to form the geometry desired for the center leg portion 20. For example, in one embodiment according to the present disclosure, two edges of each of the first panel 150 are joined together to form a cylinder; two edges of the second panel 160 are joined together to form a cylinder; and two edges of the corrugated panel 170 may be joined together to form a cylinder such that the composite assembly 100 forms a generally cylindrical center leg portion 20 similar to that shown in FIG. 2. In other embodiments, the composite assembly 100 may have corrugations similar to that shown in FIG. 3 such that when the composite assembly 100 is bent into a cylindrical shape it has a cross-section similar that shown in FIG. 3. The edges of the first panel 150, the second panel 160 and the corrugated panel 170 may be joined together by laser welding, plasma arc welding, electric arc welding, gas welded, friction stir welding and brazing. Alternatively, the edges of the first panel 150, the second panel 160 and the corrugated panel 170 may be joined together using adhesives such as epoxy, glue, and mechanical fasteners such as bolts and rivets. The means used to join the edges of the first panel 150, the second panel 160 and the corrugated panel 170, however, may not be limited to the aforementioned.

### INDUSTRIAL APPLICABILITY

In general, the technology described in the present disclosure has industrial applicability in a variety of settings such as, but not limited to, improving operating efficiencies of differential axles by reducing the weight of the axle housing while maintaining its strength. Its industrial applicability extends to virtually all motorized transport platforms, including automobiles, buses, trucks, tractors, industrial work machines and most off-road machines utilized in agriculture, mining, and construction.

The disclosed method of fabricating an axle housing assembly 10 allows for the center leg portion 20 to be easily fabricated rather than cast from steel or iron. The disclosed method is simpler and requires fewer steps compared to a complex steel or iron casting. The disclosed axle housing assembly 10 may also offer a considerable cost savings by reducing the amount of steel or iron used in forming the axle housing assembly 10. The disclosed light weight axle housing assembly 10 offers great flexibility in the design of the axle housing as the geometry and material thickness can be modified to meet the needs of the application. Among other attributes, the assembly 10 of the present disclosure may find applicability in customizing the strength and the weight of the axle housing assembly 10 by using a polymeric material having certain properties to fill the channel regions 80 of the center leg portion 20. Ultimately, the disclosed light weight axle housing assembly 10 may achieve numerous advantages such as improved performance over standard steel or iron castings, promoting enhanced operational efficiency including lower fuel requirements.

The features disclosed herein may be particularly beneficial to wheel loaders and other earth moving, construction, mining or material handling vehicles that utilize oil filled axle housings.

We claim:

1. An axle housing assembly for a vehicle comprising:
a center leg portion;
an outer bearing configured to mount onto one end of the center leg portion; and a differential housing configured to mount onto an opposite end of the center leg portion;
wherein the center leg portion comprises:
a first metal sleeve;
a second metal sleeve surrounding the first metal sleeve; and
a corrugated inner sleeve arranged between the first and second metal sleeves, having a series of corrugations comprising first portions and second portions wherein the first portions are affixed to the first metal sleeve and the second portions are affixed to the second metal panel to form a plurality of channel regions between the corrugations and the first metal panel and the second metal panel.

2. The axle housing assembly of claim 1, wherein the center leg portion has a generally circular cross-section.

3. The axle housing assembly of claim 2, wherein the center leg portion has a diameter that is not uniform.

4. The axle housing assembly of claim 1, wherein the channel regions are at least partially filled by a polymeric material.

5. The axle housing assembly of claim 1, wherein the first portions are laser welded to the first metal sleeve and the second portions are laser welded to the second metal sleeve.

6. The axle housing assembly of claim 1, wherein at least one of the first metal sleeve and the second metal sleeve is steel.

7. The axle housing assembly of claim 1, wherein the corrugations include arc portions that are affixed to the first and second metal sleeves.

8. The axle housing assembly of claim 1, wherein the corrugations are curved.

9. At axle housing comprising:
a center leg portion having attaching structure configured to attach to a differential housing;
a first sleeve defining an outer perimeter of the center leg portion;
a second sleeve containing the first sleeve;
a corrugated section connecting the first sleeve with the second sleeve, wherein the corrugated section, the first sleeve, and the second sleeve define channel regions within the axle housing.

10. The axle housing of claim 9, wherein the corrugated section is at least one of either: sinusoidal in cross-section and includes arc portions connected by straight sections.

11. The axle housing of claim 9, wherein the corrugated section is laser welded to the first sleeve and the second sleeve.

12. The axle housing of claim 9, wherein the channel regions run a length associated with the center leg portion.

13. The axle housing of claim 9, wherein the center leg portion further comprises a second and third attaching structure wherein the second attaching structure is configured to allow the center leg portion to attach to an outer bearing and the third attaching structure is configured to attach the center leg portion to a vehicle.

14. The axle housing of claim 9, further comprising a material in at least one of the channel regions configured to provide additional strength to the axle housing.

15. The axle housing of claim 14, wherein the material is polyurethane.

16. A method of assembling an axle housing comprising:
connecting an inner sleeve and an outer sleeve with a corrugated portion to form a center leg portion;
attaching the center leg portion to an outer bearing; and
forming channel regions defined by the inner sleeve, the outer sleeve, and the corrugated portion,
wherein at least one of the inner sleeve, the outer sleeve, and the corrugated portion is metal.

17. The method of claim 16, further comprising flowing a fluid through at least one channel region.

18. The method of claim 16, further comprising installing a conduit in at least one channel.

19. The method of claim 16, further comprising filling at least in part one channel region with a material configured to provide additional strength to the axle housing.

20. The method of claim 16 further comprising the steps of:
forming the inner sleeve by flexing and joining together two edges of a first panel;
forming the outer sleeve by flexing and joining together two edges of a second panel; and forming the corrugated portion by flexing and joining together two edges of a corrugated panel.
